(19) United States
(12) Patent Application Publication
(10) Pub. No.: US 2026/0313229 A1
(43) Pub. Date: Oct. 8, 2026

(54) IMAGING DEVICE, SUBSTRATE OBSERVATION APPARATUS, SUBSTRATE PROCESSING APPARATUS, AND IMAGING METHOD

(71) Applicant: SCREEN Holdings Co., Ltd., Kyoto (JP)

(72) Inventor: Daisuke HISHITANI, Kyoto (JP)

(21) Appl. No.: 19/478,886

(22) PCT Filed: Apr. 5, 2024
(86) PCT No.: PCT/JP2024/014070

§ 371 Date: Oct. 27, 2025

(30) Foreign Application Priority Data
Apr. 28, 2023 (JP) 2023-073951

(51) Int. Cl. H04N 23/667; G01N 21/88; G01N 21/95; H04N 23/73

(52) U.S. Cl. CPC H04N 23/667; G01N 21/8851; G01N 21/9501; H04N 23/73; G01N 2201/103

(57) ABSTRACT

In each of an imaging device, a substrate observation apparatus, a substrate processing apparatus, and an imaging method, imager cyclically switches a plurality of imaging conditions for each imaging and the plurality of imaging conditions include a first condition corresponding to imaging of the first figure and a second condition corresponding to imaging of the second figure, and the image processor acquires the first image from an image captured by the imager under the first condition and acquires the second image from an image captured by the imager under the second condition. Therefore, it is possible to provide the image obtained by viewing the peripheral edge part of the substrate from the plurality of directions for observation with excellent image quality.

### TECHNICAL FIELD

This invention relates to a technique for imaging a peripheral edge part of a substrate such as a semiconductor wafer or the like for the purpose of, for example, inspection or the like.

### BACKGROUND

A processing system for performing various types of processing on a peripheral edge part of an object to be imaged, such as a semiconductor wafer or the like, is well known. In such a substrate processing system, for observing a processing state, for example, a substrate to be processed is illuminated and imaged by an imager such as a CCD camera or the like. As a shape of the peripheral edge part of the substrate, there can be various shapes. For example, the peripheral edge part is provided with a so-called bevel part whose surface is finished to be an inclined surface by polishing.

For the purpose of observing a finished condition in such a bevel part of the substrate, it is not sufficient to use only an image obtained by imaging the substrate from one direction. In other words, the peripheral edge part of the substrate has various cross-sectional shapes and it is therefore impossible to observe the entire peripheral edge part by using only the image captured from one direction. Further, a surface state of the substrate also varies by areas such as a main surface, a side surface, and the like, and also depending on the processing state. For this reason, also as to the imaging condition such as an illuminated state, an exposure time, or the like, it is sometimes difficult to obtain an excellent image suitable for observation by single setting.

A technique applicable to imaging under such a condition is disclosed, for example, in Patent Literature 1. This technique relates to an imaging system using a digital camera in which a CCD or CMOS sensor, for example, serves as an imaging element. In this technique, achieved are functions of storing a plurality of imaging conditions which are set in advance into a storage of the camera, performing imaging while switching these imaging conditions for each imaging, and outputting imaging data.

### CITATION LIST

### Patent Literature

[Patent Literature 1] Patent Publication No. 4224504

### SUMMARY

### Technical Problem

Also for the purpose of observing the peripheral edge part of the substrate including the bevel part, by using the above-described functions, it is expected to image the peripheral edge part of the substrate under various imaging conditions to observe the peripheral edge part in a multifaceted way. Any specific method for imaging the peripheral edge part of the substrate by using these functions, however, has not been proposed yet.

### Solution to Problem

This invention is intended to solve the above-described problem, and it is an object of the present invention to provide a technique for acquiring an image suitable for observing a peripheral edge part of a substrate in a multifaceted way from a plurality of directions by performing imaging while switching imaging conditions for each imaging.

One aspect of this invention is an imaging device for imaging a peripheral edge part of a substrate being rotated. The device comprises: an imager configured to periodically perform imaging; an optical guider configured to guide light emitted from the peripheral edge part to the imager so as to form a first figure of the peripheral edge part viewed from a first direction and a second figure of the peripheral edge part viewed from a second direction different from the first direction in an imaging field of view of the imager; and an image processor configured to perform image processing on each of a first image including the first figure and a second image including the second figure, the first image and the second image being captured by the imager, wherein the imager cyclically switches a plurality of imaging conditions for each imaging, the imaging conditions including a first condition corresponding to imaging of the first figure and a second condition corresponding to imaging of the second figure, and the image processor acquires the first image from an image captured by the imager under the first condition and acquires the second image from an image captured by the imager under the second condition.

Other aspect of the invention is an imaging method for imaging a peripheral edge part of a substrate being rotated. The method comprises: periodically performing imaging by an imager while guiding light emitted from the peripheral edge part to the imager, to thereby form a first figure of the peripheral edge part viewed from a first direction and a second figure of the peripheral edge part viewed from a second direction different from the first direction in an imaging field of view of the imager; and performing image processing on each of a first image including the first figure and a second image including the second figure, which are captured by the imager, wherein the imager cyclically switches a plurality of imaging conditions for each imaging, the plurality of imaging conditions including a first condition corresponding to imaging of the first figure and a second condition corresponding to imaging of the second figure, and an image processor acquires the first image from an image captured by the imager under the first condition and acquires the second image from an image captured by the imager under the second condition.

In each of these aspects of this invention, the imager cyclically switches a plurality of imaging conditions for each imaging and the plurality of imaging conditions include a first condition corresponding to imaging of the first figure and a second condition corresponding to imaging of the second figure, and the image processor acquires the first image from an image captured by the imager under the first condition and acquires the second image from an image captured by the imager under the second condition.

In the invention configured thus, the imaging field of view of the imager includes all the plurality of figures of the peripheral edge part of the substrate viewed from the different directions. Therefore, the image obtained by imaging the imaging field of view can be used for the purpose of observing the peripheral edge part of the substrate from the plurality of directions. The imaging conditions suitable for imaging the plurality of respective figures, however, are not necessarily the same. Thus, in the present invention, imaging is performed by cyclically switching the plurality of imaging conditions for each imaging.

Specifically, the imaging conditions which are cyclically switched include the first condition as the imaging condition for imaging of the first figure which is a figure of the peripheral edge part viewed from the first direction and the second condition as the imaging condition for imaging of the second figure which is a figure of the peripheral edge part viewed from the second direction. Therefore, in the periodic imaging performed by the imager, the imaging under the first condition and the imaging under the second condition are repeatedly performed.

Then, the image processor acquires the first image including the first figure, from an image captured under the first condition and acquires the second image including the second figure, from an image captured under the second condition, and performs image processing on these images. It is therefore possible to obtain excellent image quality by imaging the first figure in the first image and the second figure in the second image under appropriate imaging conditions.

Thus, the present invention is configured by combining the optical guider for guiding light emitted from the substrate to the imager so that the plurality of figures of the peripheral edge part of the substrate viewed from different directions can be included in the imaging field of view of the imager, the imager for periodically acquiring images while cyclically changing the plurality of imaging conditions, and the image processor which determines an image captured under the imaging condition set corresponding to each figure as a processing target. For this reason, it is possible to provide the image obtained by viewing the peripheral edge part of the substrate from the plurality of directions for observation with excellent image quality.

Further, this invention can be achieved as a substrate observation apparatus including a rotating mechanism configured to hold a substrate and to rotate the substrate about an axis of rotation perpendicular to a main surface of the substrate and an imaging mechanism having the same configuration as that in the above-described imaging device, or a substrate processing apparatus including a rotating mechanism configured to hold a substrate and to rotate the substrate about an axis of rotation perpendicular to a main surface of the substrate, a processor configured to perform predetermined processing on the substrate being rotated, and an imaging mechanism having the same configuration as that in the above-described imaging device. In the invention configured thus, according to the above-described principle, it is possible to effectively observe the peripheral edge part of the substrate from the plurality of directions.

### Advantageous Effects of Invention

According to this invention, imaging is performed while the imaging conditions are switched corresponding to each figure for each imaging in the state where all the figures of the peripheral edge part of the substrate viewed from the plurality of directions are present in the imaging field of view, and an image captured under an appropriate imaging condition among those imaging conditions is selected, to be processed. For this reason, this invention is suitable for observing the peripheral edge part of the substrate from the plurality of directions in a multifaceted way, and it is possible to acquire an image having an excellent image quality.

The foregoing objects and other objects, and new characteristics of the present invention will become more apparent completely by reading detailed description given below by referring to the accompanying drawings. The drawings are merely for explanation and are not intended to limit the scope of the invention.

### BRIEF DESCRIPTION OF DRAWINGS

FIG. 1 is a diagram showing one embodiment of a substrate processing apparatus in accordance with the present invention;

FIG. 2 is a diagram schematically showing a configuration of the substrate processing apparatus;

FIG. 3 is a plan view of part of the substrate processing apparatus viewed from above;

FIG. 4 is a diagram exemplarily showing a shape of a peripheral edge part of a substrate to be imaged;

FIG. 5 is a block diagram showing an electrical configuration of the substrate processing apparatus;

FIG. 6A is a perspective view showing a head unit of an imaging mechanism;

FIG. 6B is another perspective view showing the head unit of the imaging mechanism;

FIG. 7A is a view schematically showing how light contributing to upper surface imaging propagates;

FIG. 7B is another view schematically showing how the light contributing to the upper surface imaging propagates;

FIG. 8A is a view schematically showing how light contributing to side surface imaging propagates;

FIG. 8B is another view schematically showing how the light contributing to the side surface imaging propagates;

FIG. 9 is a chart schematically showing images of the peripheral edge part of the substrate captured by an imager;

FIG. 10 is a block diagram showing an exemplary configuration of the imager in this embodiment;

FIG. 11 is a chart showing exemplary imaging conditions;

FIG. 12 is a flowchart showing an imaging operation performed by the imager;

FIG. 13 is a conceptual diagram showing processing for forming an entire peripheral edge image from an imaging result;

FIG. 14 is a flowchart showing image processing applicable to the formation of the entire peripheral edge image;

FIG. 15 is a diagram showing a preferable relation between an imaging timing and a rotation speed of the substrate; and

FIG. 16 is a flowchart showing a variation of the image processing.

### DESCRIPTION OF EMBODIMENTS

FIG. 1 is a diagram showing a substrate processing system equipped with one embodiment of a substrate processing apparatus in accordance with the present invention. The substrate processing system 200 includes a substrate processing station 210 for processing a disk-like substrate S such as a semiconductor wafer or the like and an indexer station 220 coupled to this substrate processing station 210. The indexer station 220 includes a container holder 221 capable of holding a plurality of containers C (FOUPs (Front Opening Unified Pods), SMIF (Standard Mechanical Interface) pods, OCs (Open Cassettes), or the like for housing a plurality of substrates S in a sealed state) for housing the substrates S, and an indexer robot 222 for accessing the container C held by this container holder 221 to take out an unprocessed substrate S from the container C and house a processed substrate S into the container C. In each container C, a plurality of substrates S are housed substantially in a horizontal posture.

In the present specification, among both main surfaces of the substrate S, a pattern formation surface (one main surface) on which a pattern is formed is referred to as a “front surface” and the other main surface on the opposite side, on which no pattern is formed, is referred to as a “back surface”. Further, a surface facing down is referred to as a “lower surface” and another surface facing up is referred to as an “upper surface”. Furthermore, in the present specification, the “pattern formation surface” refers to a surface of the substrate on which a projection-depression pattern is formed in an arbitrary region.

The indexer robot 222 includes a base 222a fixed to an apparatus housing, an articulated arm 222b provided on the base 222a, rotatably about a vertical axis, and a hand 222c mounted on a tip of the articulated arm 222b. The hand 222c is structured such that the substrate S can be placed and held on an upper surface thereof. Such an indexer robot including the articulated arm and the hand for holding the substrate is well known and therefore will not be described in detail.

The substrate processing station 210 includes a substrate conveyor robot 211 arranged substantially in a center in a plan view and a plurality of processing units 1 arranged to surround this substrate conveyor robot 11. Specifically, the plurality of processing units 1 are arranged to face a space where the substrate conveyor robot 211 is arranged. Main constituent elements of the processing unit 1 are arranged inside a processing chamber 100. The substrate conveyor robot 211 timely accesses these processing units 1 to transfer the substrates S. On the other hand, each processing unit 1 performs predetermined processing on the substrate S. In the present embodiment, one of these processing units 1 corresponds to the substrate processing apparatus in accordance with the present invention.

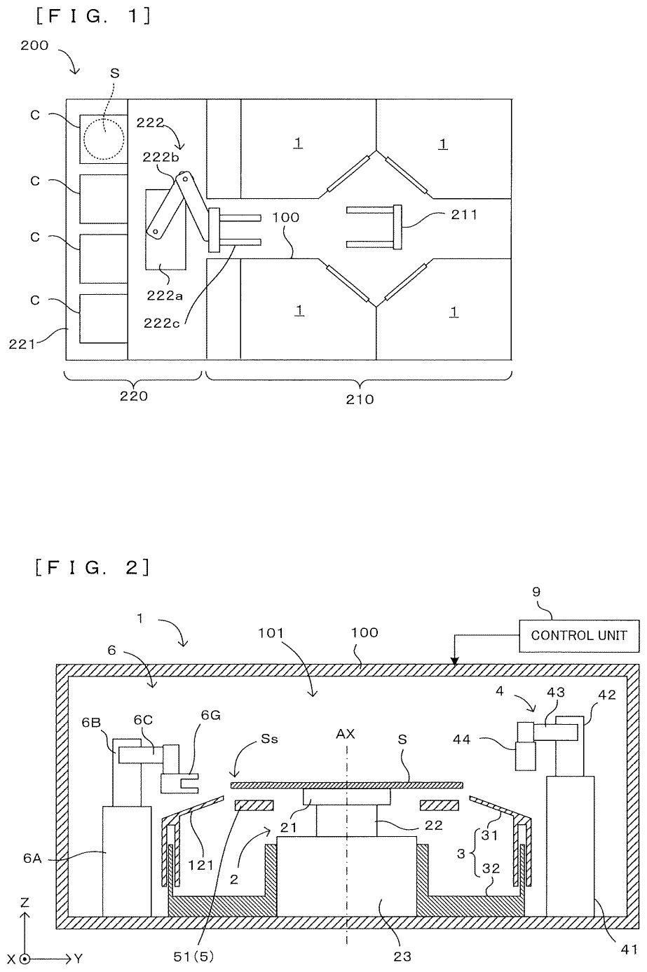

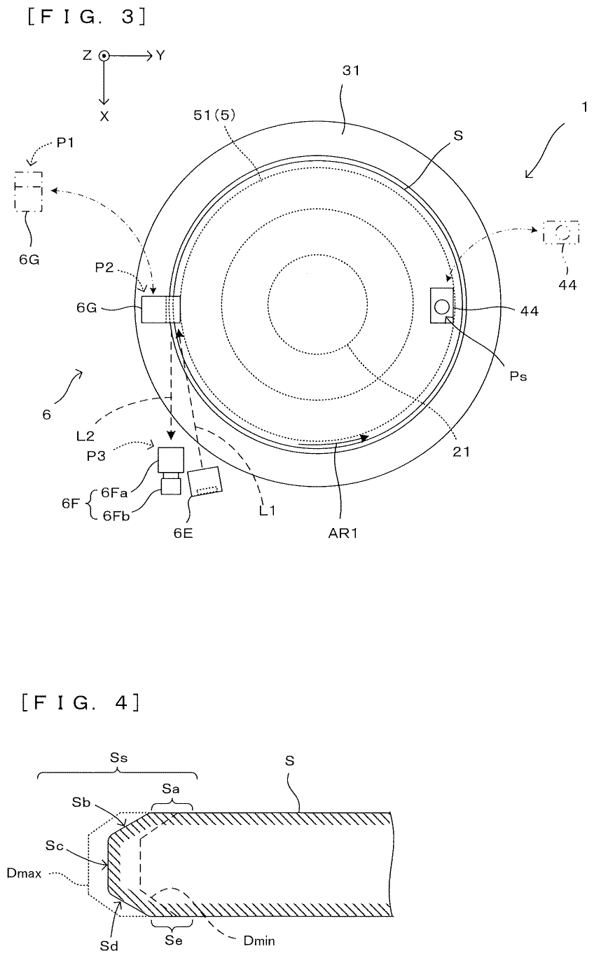

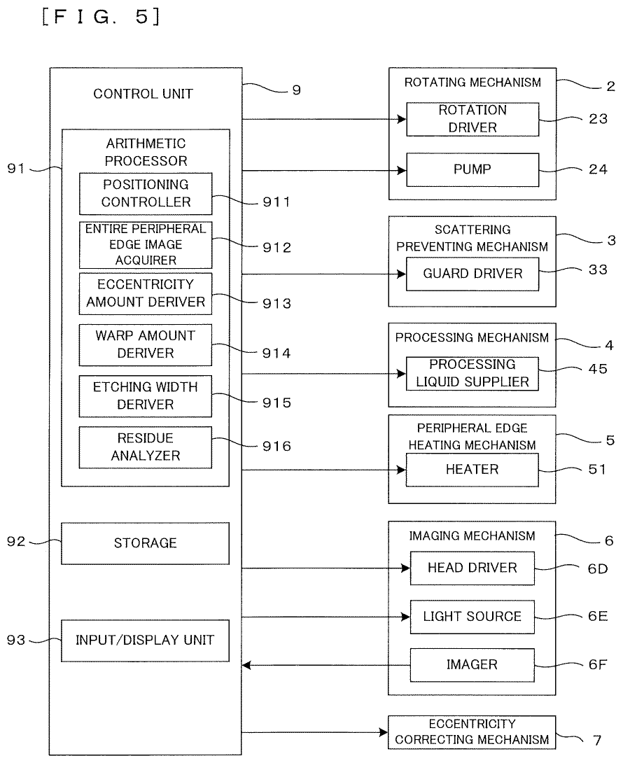

FIG. 2 is a diagram schematically showing a configuration of the substrate processing apparatus. FIG. 3 is a plan view of part of the substrate processing apparatus viewed from above. FIG. 4 is a diagram exemplarily showing a shape of a peripheral edge part of a substrate to be imaged. FIG. 5 is a block diagram showing an electrical configuration of the substrate processing apparatus shown in FIGS. 2 and 3. In FIGS. 2 and 3 and each figure to be referred to below, each component is sometimes shown with the dimensions and the number thereof exaggerated or simplified to facilitate understanding. Further, to clarify a directional relationship, a coordinate system in which a Z axis extends in a vertical direction and an XY plane is a horizontal plane is added as appropriate in each figure.

A substrate processing apparatus (processing unit) 1 is provided with a rotating mechanism 2, a scattering preventing mechanism 3, a processing mechanism 4, a peripheral edge heating mechanism 5, and an imaging mechanism 6. Each of these mechanisms 2 to 6 is housed in an internal space 101 of the processing chamber 100. Each of the mechanisms 2 to 6 is electrically connected to a control unit 9 for controlling the entire apparatus and operates in response to an instruction from the control unit 9.

As the control unit 9, for example, a unit like a general computer can be adopted. Specifically, in the control unit 9, a CPU serving as an arithmetic processor 91 performs arithmetic processing in accordance with a procedure described in a program, thereby controlling each component of the substrate processing apparatus 1. The substrate processing apparatus 1 thereby performs bevel etching processing by supplying a processing liquid to a peripheral edge part of an upper surface of the substrate S in the processing chamber. Furthermore, the detailed configuration and operation of the control unit 9 will be described in detail later. Further, although the control unit 9 is provided for each substrate processing apparatus 1 in the present embodiment, there may be a configuration where a plurality of substrate processing apparatuses 1 are controlled by one control unit. Furthermore, there may be another configuration where the substrate processing apparatus 1 is controlled by a control unit (not shown) for controlling the entire substrate processing system 200.

The rotating mechanism 2 rotates the substrate S in a rotational direction AR1 (FIG. 3) while holding the substrate S substantially in a horizontal posture with the surface of the substrate S facing up. The rotating mechanism 2 rotates the substrate S about a vertical axis of rotation AX passing through a center of the main surface of the substrate S. The rotating mechanism 2 includes a spin chuck 21, which is a disk-like member smaller than the substrate S. The spin chuck 21 is so provided that an upper surface thereof is substantially horizontal and a center axis thereof coincides with the axis of rotation AX. A rotary shaft 22 is coupled to a lower surface of the spin chuck 21. The rotary shaft 22 extends in a vertical direction with an axis thereof aligned with the axis of rotation AX. Further, a rotation driver (e.g., a motor) 23 is connected to the rotary shaft 22. The rotation driver 23 rotates and drives the rotary shaft 22 about the axis thereof in response to a rotation command from the control unit 9. Therefore, the spin chuck 21 is rotatable about the axis of rotation AX together with the rotary shaft 22. The rotation driver 23 and the rotary shaft 22 provide a function of rotating the spin chuck 21 about the axis of rotation AX.

An unillustrated through hole is provided in a central part of the spin chuck 21 and communicates with an internal space of the rotary shaft 22. A pump 24 (FIG. 5) is connected to the internal space via a pipe having a valve (not shown) disposed therein. The pump 24 and the valve are electrically connected to the control unit 9 and operate in response to a command from the control unit 9. A negative pressure and a positive pressure are thereby selectively applied to the spin chuck 21. For example, when the pump 24 applies the negative pressure to the spin chuck 21 with the substrate S placed substantially in a horizontal posture on the upper surface of the spin chuck 21, the spin chuck 21 sucks and holds the substrate S from below. On the other hand, when the pump 24 applies the positive pressure to the spin chuck 21, the substrate S becomes removable from the upper surface of the spin chuck 21. Further, when the suction of the pump 24 is stopped, the substrate S becomes horizontally movable on the upper surface of the spin chuck 21.

The scattering preventing mechanism 3 includes a substantially tubular cup 31 provided to surround an outer periphery of the substrate S held on the spin chuck 21 as shown in FIG. 3 and a liquid receiver 32 provided below an outer peripheral part of the cup 31. A guard driver 33 (FIG. 5) operates in response to a control command from the control unit 9, whereby the cup 31 is raised and lowered. When the cup 31 is positioned at a lower position, an upper end part of the cup 31 is located below a peripheral edge part Ss of the substrate S held on the spin chuck 21 as shown in FIG. 2. Conversely, when the cup 31 is positioned at an upper position, the upper end part of the cup 31 is located above the peripheral edge part Ss of the substrate S.

When the cup 31 is located at the lower position, the substrate S held on the spin chuck 21 is exposed to the outside of the cup 31 as shown in FIG. 2. This prevents the cup 31 from becoming a hindrance, for example, when the substrate S is carried into and from the spin chuck 21.

On the other hand, when the cup 31 is located at the upper position, an inner peripheral surface of the cup 31 surrounds the outer periphery of the substrate S held on the spin chuck 21. It is thereby possible to prevent droplets of the processing liquid shaken off from the peripheral edge part Ss of the substrate S during the bevel etching processing described later from being scattered in the processing chamber 100. Further, it becomes possible to reliably collect the processing liquid. Specifically, the droplets of the processing liquid shaken off from the peripheral edge part Ss of the substrate S by the rotation of the substrate S adhere to the inner peripheral surface of the cup 31, flow down and are gathered and collected by the liquid receiver 32 arranged below the cup 31.

The processing mechanism 4 includes a base 41, a pivot shaft 42, an arm 43, and a processing liquid nozzle 44. The base 41 is fixed to the processing chamber 100. The pivot shaft 42 is freely rotatably provided on this base 41. The arm 43 horizontally extends from the pivot shaft 42, and the processing liquid nozzle 44 is attached to a tip of the arm 43. The pivot shaft 42 turns in response to a control command from the control unit 9, whereby the arm 43 swings. The processing liquid nozzle 44 on the tip of the arm 43 thereby moves between a retracted position where the processing liquid nozzle 44 is retracted laterally from above the substrate S to the side thereof and a processing position above the peripheral edge part of the substrate S. FIG. 3 shows a state indicated by the two-dot chain line, where the nozzle 44 is located at the retracted position and another state indicated by the solid line, where the nozzle 44 is located at the processing position.

The processing liquid nozzle 44 is connected to a processing liquid supplier 45 (FIG. 5). Then, when the processing liquid supplier 45 supplies the processing liquid toward the processing liquid nozzle 44 in response to a supply command from the control unit 9, the processing liquid is discharged from the processing liquid nozzle 44 toward a processing start position Ps. This processing start position Ps is one point on a movement path of the peripheral edge part Ss of the substrate S. Accordingly, the spin chuck 21 rotates while the processing liquid nozzle 44 is discharging the processing liquid, whereby each part of the peripheral edge part Ss of the substrate S receives the supply of the processing liquid while passing through the processing start position Ps. As a result, the bevel etching processing is performed by using the processing liquid on the entire peripheral edge part Ss of the substrate S.

The peripheral edge heating mechanism 5 is provided with an annular heater 51. The heater 51 includes a built-in heating element extending in a circumferential direction of the substrate S along a peripheral edge part of the lower surface of the substrate S. When a heating command is given to this heater 51 from the control unit 9, the peripheral edge part Ss of the substrate S is heated from below by heat released from the heating element. The temperature of the peripheral edge part Ss thereby increases to a value suitable for the bevel etching processing.

The imaging mechanism 6 includes a base 6A, a pivot shaft 6B, an arm 6C, a head driver 6D, a light source 6E, an imager 6F and a head unit 6G. The base 6A is fixed to the processing chamber 100. The pivot shaft 6B is freely rotatably provided on this base 6A. The arm 6C horizontally extends from the pivot shaft 6B, and the head unit 6G is attached to a tip of the arm 6C. Then, when a control command from the control unit 9 is given to the head driver 6D (FIG. 5) for driving the arm 6C, the head driver 6D swings the arm 6C in response to this command. As shown by the one-dot chain line in FIG. 3, the head unit 6G attached to the tip of the arm 6C reciprocates between a retracted position P1 where the head unit 6G is retracted laterally from above the substrate S to the side thereof and an imaging position P2 where the peripheral edge part Ss of the substrate S is imaged. FIG. 3 shows a state indicated by the one-dot chain line, where the head unit 6G is located at the retracted position P1 and another state indicated by the solid line, where the head unit 6G is located at the imaging position P2. At the imaging position P2, the head unit 6G is disposed in proximity to an end part of the substrate S on the (−Y) side.

As shown in FIG. 3, the light source 6E and the imager 6F are provided at a separated position P3 separated from the imaging position P2 in an X direction. This separated position P3 is separated from the substrate S and the respective components (the rotating mechanism 2, the scattering preventing mechanism 3, the processing mechanism 4, and the peripheral edge heating mechanism 5) for performing the bevel etching processing, such as the cup 31 and the like. The light source 6E emits illumination light L1 toward the imaging position P2 from the outside of the cup 31. At this time, the cup 31 is positioned at the lower position, the head unit 6G is positioned at the imaging position P2, and the illumination light L1 enters the head unit 6G. This illumination light L1 is diffusely reflected on the head unit 6G. The peripheral edge part Ss of the substrate S is illuminated with diffused light generated in this way. Then, reflected light L2 reflected on the peripheral edge part Ss of the substrate S is further reflected on the head unit 6G. The reflected light L2 is guided toward the separated position P3 from the head unit 6G and enters the imager 6F. The imager 6F thereby acquires an image of the peripheral edge part Ss of the substrate S and sends image data thereof to the control unit 9.

Herein, the peripheral edge part Ss of the substrate S to be imaged in the present embodiment will be described with reference to FIG. 4. As shown in FIG. 4, the substrate S such as a semiconductor wafer or the like sometimes has a bevel part having an inclined surface, which is formed at the peripheral edge part thereof. The “bevel part” described herein refers to an entire region in a state where a surface of the substrate S is inclined with respect to a horizontal plane when the substrate S is in a horizontal posture.

As to the cross-sectional shape and the dimensions of the bevel part, maximum dimensions Dmax indicated by the dotted line in this figure and minimum dimensions Dmin indicated by the broken line are defined as standards, and as long as the dimensions thereof fall into this range, generally, relatively high degree of freedom is given thereto. There are many cases where the cross section of the bevel part is constituted of a plurality of planes having different tilts as shown in FIG. 4, but there are some cases where the bevel part is constituted of a continuous curved plane.

Hereinafter, if necessary, a portion in the peripheral edge part Ss of the substrate S, which is the same plane as the upper surface of the substrate S, is referred to as an “A surface” and represented by a reference sign “Sa” and an end surface of the substrate S is referred to as a “C surface” and represented by a reference sign “Sc”. Then, an inclined surface connecting the A surface Sa and the C surface Sc is referred to as a “B surface” and represented by a reference sign “Sb”. Further, another portion which is the same plane as the lower surface of the substrate S is referred to as an “E surface” and represented by a reference sign “Se” and an inclined surface connecting the C surface Sc and the E surface Se is referred to as a “D surface” and represented by a reference sign “Sd”. The “peripheral edge part Ss” in the present specification is a concept which comprehensively includes these planes.

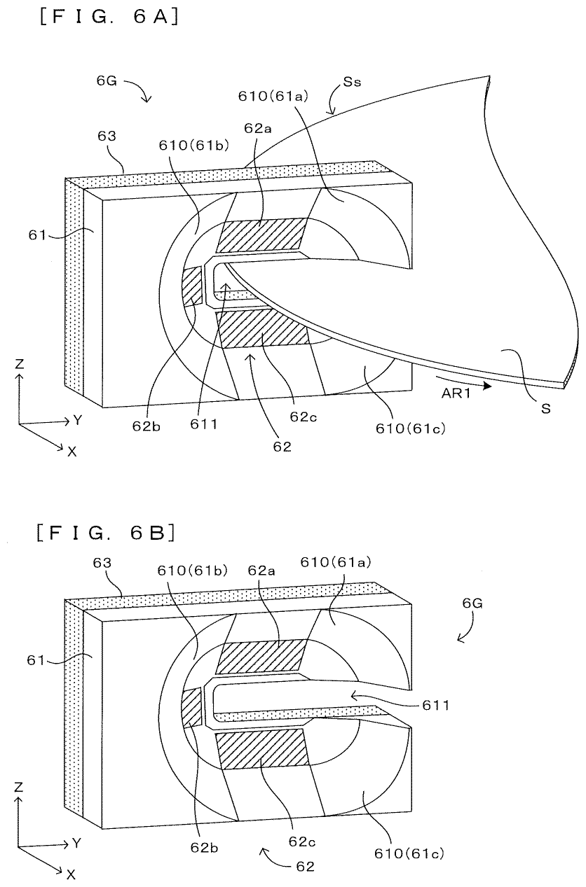

As described above, the head unit 6G includes both a diffused illumination function of receiving the illumination light L1 from the light source 6E to generate the diffused light and illuminating the peripheral edge part Ss of the substrate S with the diffused light and a guide function of guiding the reflected light L2 reflected on the peripheral edge part Ss to the imager 6F. The configuration and operation of the head unit 6G will be described below with reference to FIGS. 6A to 9.

FIGS. 6A and 6B are perspective views each showing the head unit of the imaging mechanism. More specifically, FIG. 6A is a view showing a state where the head unit 6G is disposed at the imaging position P2, and FIG. 6B is a view showing a state where the substrate S is omitted from FIG. 6A. The head unit 6G has a diffused illuminator 61 having diffusion surfaces 610, a guide 62 consisting of three mirror members 62a to 62c each surrounded by the diffusion surface 610, and a holder 63 for holding the diffused illuminator 61. In FIGS. 6A and 6B, for distinction from the diffused illuminator 61, regions which correspond to the holder 63 are dotted.

The diffused illuminator 61 is made of a white resin, for example, PTFE (polytetrafluoroethylene). The diffused illuminator 61 has a plate shape substantially in parallel to a YZ plane, and has a cut 611 formed at an end part thereof on a (+Y) direction side. This cut 611 has a shape obtained by turning a U shape clockwise by 90° as viewed from a (+X) direction side.

In the diffused illuminator 61, the diffusion surfaces 610 are provided along the cut 611. The diffusion surfaces 610 are so provided as to surround the cut 611 from upper and lower directions and a (−Y) direction, and each is a tapered surface which is so finished as to be inclined to a (−X) direction as it approaches the cut 611. The surface thereof is so finished as to diffusely reflect incident light and serves as the diffusion surface 610 for diffusely reflecting the illumination light to be incident on the peripheral edge part Ss of the substrate S, as described later.

The mirror members 62a to 62c are so attached as to be surrounded by the diffusion surfaces 610. More specifically, in the diffusion surfaces 610, the first mirror member 62a is attached at a position vertically above the cut 611, the second mirror member 62b is attached on the (−Y) side of the cut 611, and the third mirror member 62c is attached at a position vertically below the cut 611. Further, in the present embodiment, the mirror members 62a to 62c are made of Si (silicon) in consideration of chemical resistance, heat resistance, and the like.

On the other hand, the holder 63 is made of a resin having high resistance to a chemical liquid and heat, for example, PEEK (polyetheretherketone) and is a plate-like member whose outer shape is formed substantially like the diffused illuminator 61. The holder 63 is coupled to a rear surface of the diffused illuminator 61, i.e., a main surface on the (−X) side, to thereby serve as a backup member. Further, the holder 63 is coupled to the arm 6C. Therefore, with oscillation of the arm 6C, the diffused illuminator 61 and the holder 63 move as one unit between the retracted position P1 and the imaging position P2.

As shown in FIG. 6A, when the head unit 6G is positioned at the imaging position P2 and the substrate S is held by the spin chuck 21, the peripheral edge part Ss of the substrate S enters the cut 611. When the cut 611 is viewed from the (+X) side toward the (−X) direction, a portion of the peripheral edge part Ss of the substrate S, which can be seen as viewed from above, i.e., a figure of the A surface Sa and the B surface Sb is reflected in the first mirror member 62a. Similarly, a portion of the peripheral edge part Ss of the substrate S, which can be seen as viewed from side, i.e., a figure of the B surface Sb, the C surface Sc, and the D surface Sd is reflected in the second mirror member 62b. Further, a portion of the peripheral edge part Ss of the substrate S, which can be seen as viewed from below, i.e., a figure of the D surface Sd and the E surface Se is reflected in the third mirror member 62c.

As described later in detail, the imager 6F performs imaging with an imaging field of view which is so set as to encompass all the three mirror members 62a to 62c from the (+X) side. The respective figures of the substrate S which are reflected in the mirror members 62a to 62c are captured in one image. In other words, the imager 6F can collectively image all the A surface Sa, the B surface Sb, the C surface Sc, the D surface Sd, and the E surface Se of the substrate Ss to be captured into one image. By performing imaging a plurality of times with rotation of the substrate S, it is possible to acquire images of a plurality of regions in the peripheral edge part Ss, which are different in the position along the circumferential direction.

In the following description, the imaging of a figure of the A surface Sa and the B surface Sb of the substrate S, which is reflected in the first mirror member 62a, is referred to as “upper surface imaging”. Further, the imaging of a figure of the B surface Sb, the C surface Sc, and the D surface Sd of the substrate S, which is reflected in the second mirror member 62b, is referred to as “side surface imaging”. Furthermore, the imaging of a figure of the D surface Sd and the E surface Se of the substrate S, which is reflected in the third mirror member 62c, is referred to as “lower surface imaging”.

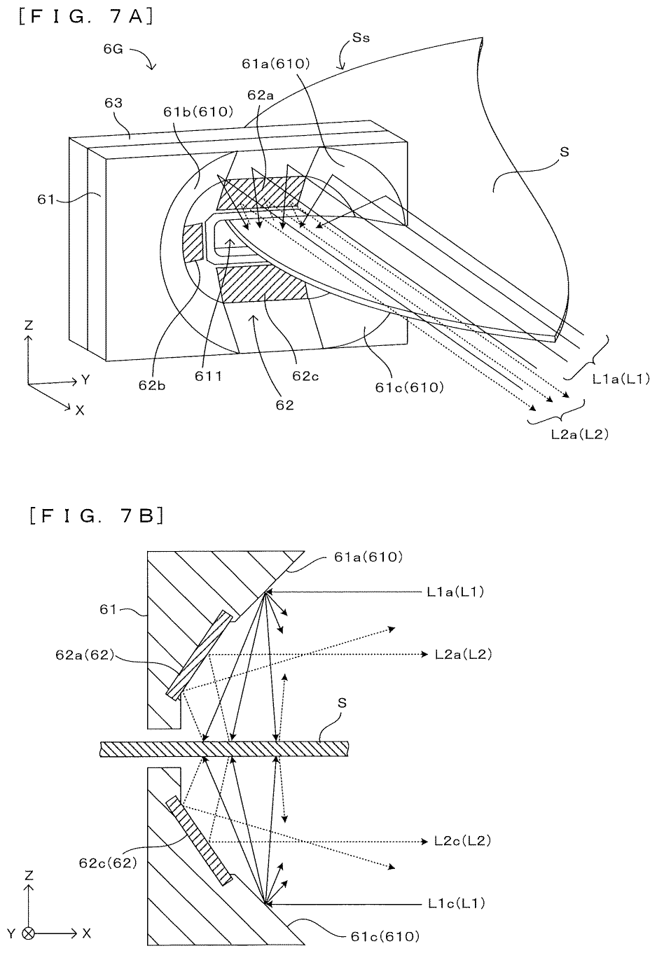

FIGS. 7A and 7B are views each schematically showing how light contributing to the upper surface imaging propagates. More specifically, FIG. 7A is a perspective view showing a course of the light which is incident and reflected on the head unit 6G, and FIG. 7B is a cross-sectional view at a vertical cross section of FIG. 7A. As indicated by solid-line arrows in FIGS. 7A and 7B, in the illumination light L1, illumination light L1a going in the (−X) direction along the upper surface side of the substrate S is incident on the diffusion surface 610 of the head unit 6G. The light which is incident on an upper diffusion surface 61a of the diffusion surface 610, particularly, which is positioned above the cut 611, and diffusely reflected thereon is incident on the upper surface of the substrate S from various directions, to thereby illuminate the peripheral edge part Ss of the substate S.

As indicated by dotted-line arrows, the reflected light reflected on the substrate S can go in various directions, but light L2a of the reflected light, which is incident on the mirror member 62a and reflected on the mirror member 62a to go in the (+X) direction, enters the imager 6F disposed on the optical path. By receiving this light, the “upper surface imaging” for imaging the peripheral edge part Ss viewed from the upper surface side of the substrate S is achieved.

As shown in FIG. 7B, also on the lower surface side of the substrate S, the same phenomenon as that on the upper surface side occurs. Specifically, the head unit 6G has a vertically symmetrical structure, and illumination light L1c of the illumination light L1, which goes in the (−X) direction along the lower surface side of the substrate S, is incident and diffusely reflected on a lower diffusion surface 61c of the diffusion surface 610, particularly, which is positioned below the cut 611, to thereby illuminate the lower surface of the substrate S. At that time, by receiving reflected light L2c reflected on the substrate S and the mirror member 62c to go toward the (+X) direction, the “lower surface imaging” for imaging the peripheral edge part Ss viewed from the lower surface side of the substrate S is achieved.

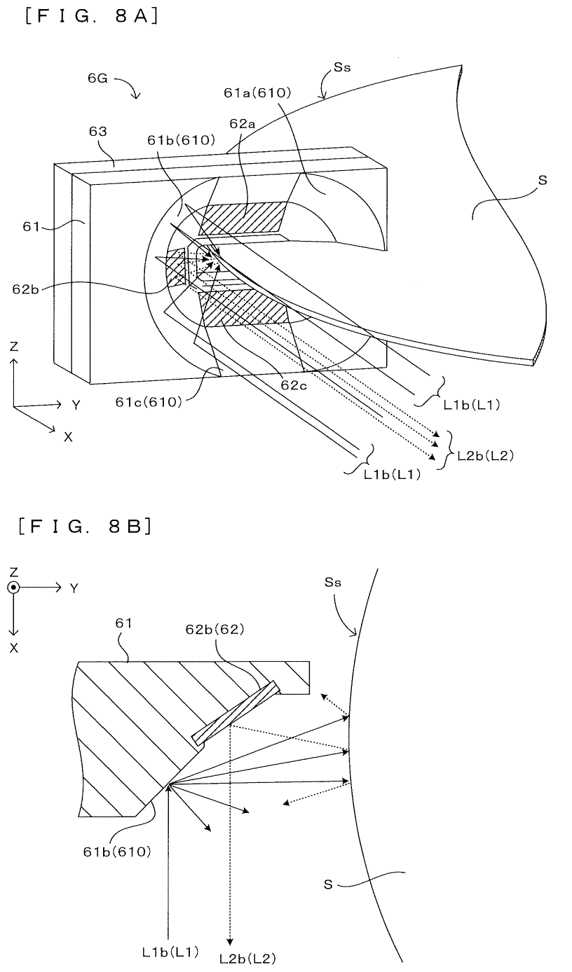

FIGS. 8A and 8B are views each schematically showing how light contributing to the side surface imaging propagates. More specifically, FIG. 8A is a perspective view showing a course of the light which is incident and reflected on the head unit 6G, and FIG. 8B is a cross-sectional view at a horizontal cross section of FIG. 8A. As indicated by solid-line arrows in FIGS. 8A and 8B, in the illumination light L1, illumination light L1b going in the (−X) direction along the side of the substrate S is incident on the diffusion surface 610 of the head unit 6G and diffusely reflected on a side diffusion surface 61b of the diffusion surface 610, particularly, which is positioned on the side of the cut 611. This light is incident on the side surface of the substrate S from various directions, to thereby illuminate the peripheral edge part Ss.

Then, in the reflected light reflected on the substrate S, as indicated by dotted-line arrows, light L2b which is reflected on the mirror member 62b to go in the (+X) direction enters the imager 6F disposed on the optical path. The “side surface imaging” for imaging the peripheral edge part Ss viewed from the side of the substrate S is achieved.

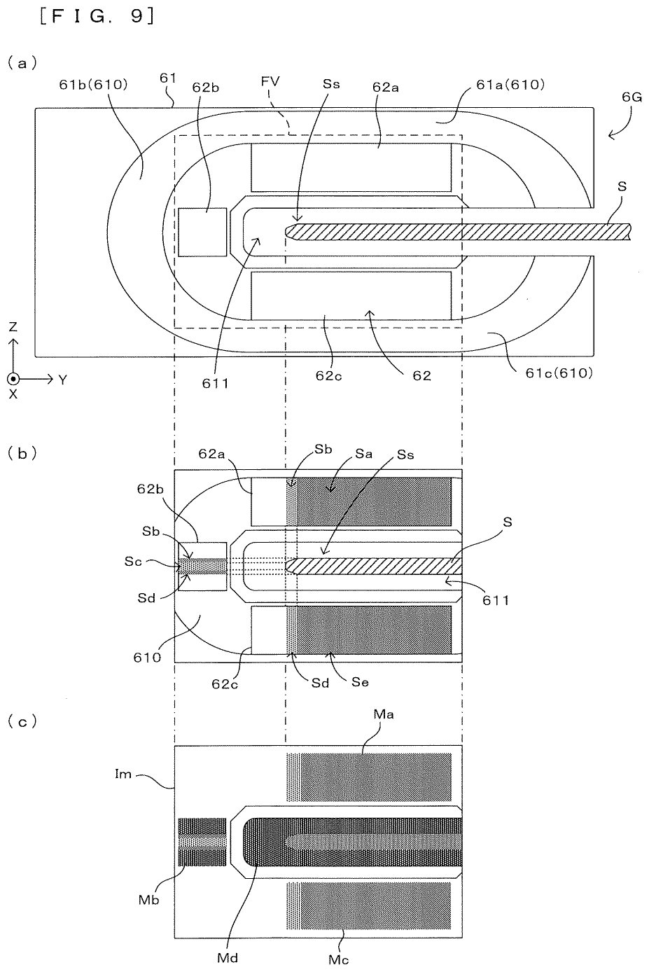

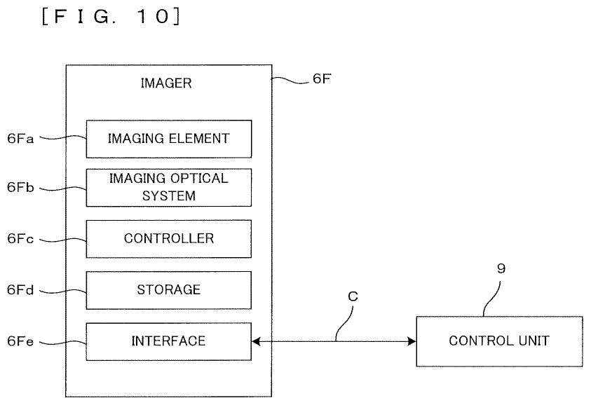

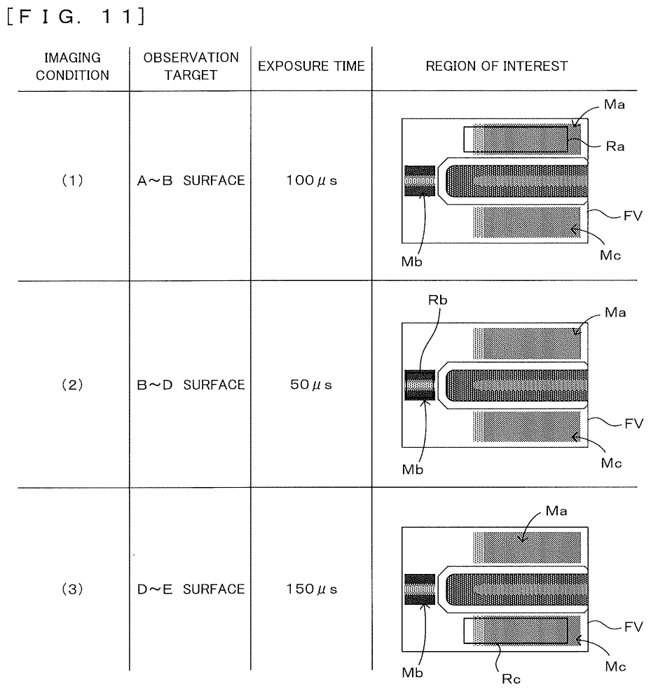

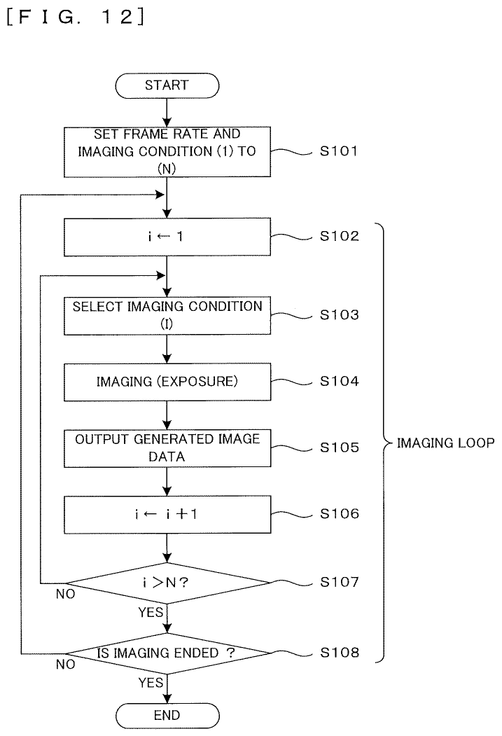

The imager 6F has an imaging optical system 6Fa consisting of object-side telecentric lens system and an imaging element 6Fb such as a CMOS camera. Therefore, in the above-described reflected light, only rays of light L2 (L2a, L2b, L2c) in parallel to the optical axis of the imaging optical system 6Fa enter a sensor surface of the imaging element 6Fb, to thereby form an image of a figure of the peripheral edge part Ss of the substrate S and an adjacent region thereof on the sensor surface. Thus, the imager 6F images the peripheral edge part Ss of the substrate S and the adjacent region thereof and acquires an image Im including an upper-surface image region Ma, a side-surface image region Mb, and a lower-surface image region Mc as shown in, for example, FIG. 9. Then, the imager 6F sends image data representing the image to the control unit 9.

FIG. 9 is a chart schematically showing images of the peripheral edge part of the substrate captured by the imager. FIG. 9(a) is a schematic diagram showing the head unit 6G and the substrate S viewed from the (+X) side toward the (−X) direction, and a region FV surrounded by the broken line represents an imaging field of view of the imager 6F. Thus, the imaging field of view FV of the imager 6F is so set as to include the mirror members 62a to 62c in the head unit 6G.

FIG. 9(b) is a view schematically showing the figures of the substrate S reflected in the respective mirror members 62a to 62c in the imaging field of view FV As shown in FIG. 9(b), in the first mirror member 62a, reflected is the figure of the A surface Sa and the B surface Sb in the peripheral edge part Ss of the substrate S. Further, in the second mirror member 62b, reflected is the figure of the B surface Sb, the C surface Sc, and the D surface Sd in the peripheral edge part Ss of the substrate S. Furthermore, in the third mirror member 62c, reflected is the figure of the D surface Sd and the E surface Se in the peripheral edge part Ss of the substrate S. The imager 6F collectively images these figures at the same time, to thereby acquire one image. The surfaces Sa to Se included in the one image are imaged at the same time and the positions in the substrate S in the circumferential direction are substantially the same.

FIG. 9(c) is a view schematically showing the image which is actually acquired by the imaging. In the imaging mechanism 6 having the above-described configuration, the illumination light from the light source 6E is diffused by the diffusion surface 610, to thereby illuminate the substrate S, and by receiving part of the reflected light from the substrate S, imaging is performed. For this reason, neither the quantity of illumination light nor the quantity of received light is sufficient. In order to perform excellent imaging in such a condition, it is necessary to increase the sensitivity of a camera, and as a result, the detailed configuration of the head unit 6G is hardly reflected on any image due to so-called overexposure or blown-out highlights.

For this reason, as shown in FIG. 9(c), the image Im which is actually acquired includes: a dark region Md which corresponds to the cut 611 and includes thereinside a figure of the side surface of the substrate S, which is reflected in an unfocused state; the upper-surface image region Ma which corresponds to a figure of the peripheral edge part Ss of the substrate S viewed from above; the side-surface image region Mb which corresponds to a figure of the peripheral edge part Ss of the substrate S viewed from side; and the lower-surface image region Mc which corresponds to a figure of the peripheral edge part Ss of the substrate S viewed from below.

By analyzing the image Im including these regions, information indicating the shape of the peripheral edge part of the substrate S in the circumferential direction, a state of etching, and the like can be acquired. Then, from these pieces of information, it is possible to inspect the eccentricity amount of the substrate S placed on the spin chuck 21 with respect to the axis of rotation AX, the warp amount of the substrate S, a bevel etching result (etching width), and the like.

Accordingly, in the substrate processing apparatus 1 equipped with the imaging mechanism 6 configured as described above, the control unit 9 controls each component of the apparatus to perform (A) substrate inspection before the bevel etching processing, (B) alignment processing, (C) bevel etching processing after the alignment processing, and (D) substrate inspection after the bevel etching processing. As shown in FIG. 5, this control unit 9 includes an arithmetic processor 91 for performing various types of arithmetic processing, a storage 92 for storing therein a basic program and image data, and an input/display unit 93 for displaying various pieces of information and receiving an input from an operator.

Then, in the control unit 9, the arithmetic processor (CPU) 91 serving as a main controller performs the arithmetic processing in accordance with a procedure described in the program, thereby controlling each component of the substrate processing apparatus 1 as follows. Specifically, as shown in FIG. 5, the arithmetic processor 91 functions as a positioning controller 911 for positioning the head unit 6G, an entire peripheral edge image acquirer 912 for acquiring an entire peripheral edge image, an eccentricity amount deriver 913 for deriving the eccentricity amount of the substrate S from the entire peripheral edge image before the bevel etching processing, a warp amount deriver 914 for deriving the warp amount of the substrate S from the entire peripheral edge image before the bevel etching processing, an etching width deriver 915 for deriving an etching width from the entire peripheral edge image after the bevel etching processing, and a residue analyzer 916 for analyzing residues from a residue enhanced image obtained by performing image processing on the entire peripheral edge image.

Further, reference numeral 7 in FIG. 5 denotes an eccentricity correcting mechanism for correcting the eccentricity of the substrate S with respect to the axis of rotation AX by moving the substrate S by the above-described eccentricity amount. Since a conventionally-known one can be used as the eccentricity correcting mechanism, the detailed configuration of the eccentricity correcting mechanism 7 will not be described herein.

As described so far, in this embodiment, the imager 6F images the peripheral edge part Ss in a state where the peripheral edge part Ss of the substrate S is inserted into the cut 611 of the head unit 6G. The substrate S is rotated at a constant speed, and while the substrate S is rotated once, the imager 6F regularly performs imaging. By synthesizing the images captured at each time, it is possible to acquire an image of the peripheral edge part Ss corresponding to the entire circumference of the substrate S, i.e., an entire peripheral edge image.

The captured image Im includes: the upper-surface image region Ma corresponding to the image of the peripheral edge part Ss viewed from above; the side-surface image region Mb corresponding to the image of the peripheral edge part Ss viewed from side; and the lower-surface image region Mc corresponding to the image of the peripheral edge part Ss viewed from below. Therefore, the entire peripheral edge image includes information on the entire circumference of the substrate S, indicating respective states of the substrate S when the peripheral edge part Ss is viewed from above, side, and below. By analyzing this entire peripheral edge image by using an appropriate image processing technique, appearance inspection of the peripheral edge part Ss can be performed.

In the imaging of the above-described image Im and the image processing on the basis of the image Im, observation is performed by using the upper-surface image region Ma, the side-surface image region Mb, and the lower-surface image region Mc which are acquired by one imaging at the same time. Actually, depending on the case, the following two problems can arise.

The first problem is a problem of the image quality of each image region described above. The surface state of the peripheral edge part Ss of the substrate S is not uniform, and there are some cases where imaging of all the surfaces cannot be performed with excellent image quality under a single imaging condition. Among the upper surface, the side surface, and the lower surface of the substrate S, especially, the types and the thicknesses of respective coating films formed thereon, respective processing states, and the like are different from one another, and therefore there are some cases where the respective surface states are largely different from one another. Due to this, the imaging conditions suitable for imaging the surfaces are not uniform. In a case, for example, where a coating film having low reflectance is formed on the upper surface of the substrate S, when exposure is so adjusted as to satisfactorily image the upper surface, overexposure sometimes occurs on the side surface side and the lower surface side to cause blown-out highlights in the image.

Conversely, when exposure is adjusted in accordance with a surface having high reflectance, there are some cases where another surface having low reflectance lacks brightness of the image, is vulnerable to image noise, and cannot obtain sufficient contrast for observation. Thus, it is sometimes difficult to image all the surfaces with excellent image quality under a single imaging condition. Further, adjustment of exposure can be achieved by increasing or reducing, for example, the quantity of illumination light and/or the exposure time.

The second problem is a problem of data capacity. The image Im includes a region other than the upper-surface image region Ma, the side-surface image region Mb, or the lower-surface image region Mc which is an observation target. Such an unused region can be removed by image processing performed by the arithmetic processor 91. An image signal to be sent from the imager 6F, however, includes data of such an unused region, and this strains the storage capacity of the storage 92 and the capacity of a communication line between the devices.

For the purpose of acquiring the entire peripheral edge image, for example, it is necessary to perform imaging multiple times in a short time while rotating the substrate S and a large amount of image data are temporarily generated. In a case where a plurality of processing units 1 are provided like in the substrate processing system 200 (FIG. 1) of this embodiment, particularly, when the plurality of processing units 1 are controlled by a single control unit 9 or the control units 9 whose number is smaller than the number of processing units 1, the image data sent out by the imager 6F in each processing unit 1 at an individual timing can largely occupy the communication line or storage resources. There is apprehension that this has a negative effect on the operation of the whole system.

In this embodiment, the imager 6F which periodically performs imaging performs imaging while cyclically switching the plurality of imaging conditions set in advance for each imaging, to thereby deal with the first problem. In the technique disclosed in Patent Literature 1, for example, a plurality of imaging conditions are registered in the storage of the imaging device in advance and the imaging condition is cyclically read out for each imaging and applied thereto, to thereby perform imaging. Such a function is referred to as a sequential shutter function, a sequencer function, or the like.

Further, in order to deal with the second problem, in the imaging field of view FV (FIG. 8A) of the imager 6F, only the region to be observed is converted into image data and sent out from the imager 6F. By not sending the image data of the unused region, it is possible to avoid the communication line or the storage resources from being strained. A function of setting part of the imaging field of view as a region of interest (ROI) and converting only a figure inside the region of interest into image data to output the image data is referred to as a ROI function, a ROI mode, or the like but hereinafter will be referred to as a “ROI setting function”.

By using this function, it becomes possible not only to simply reduce the amount of data but also, for example, to differentiate the image quality level between a necessary region and any other region or increase a frame rate to be higher than usual by omitting scan of the unnecessary region.

The imaging device having both the sequential shutter function and the ROI setting function described above is also commercially available as an industrial camera. Also in the present embodiment, the imaging device having such functions can be used as the imager 6F.

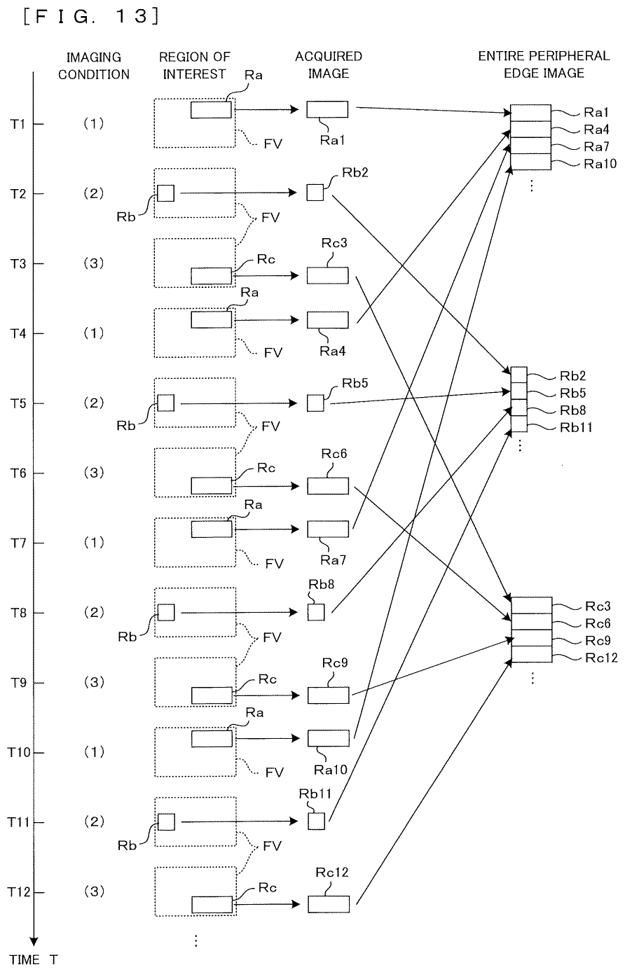

FIG. 10 is a block diagram showing an exemplary configuration of the imager in this embodiment. The imager 6F is a camera which is commercially available as the imaging device having the sequential shutter function and the ROI setting function described above and is provided with the imaging optical system 6Fa, the imaging element 6Fb, a controller 6Fc, a storage 6Fd, an interface 6Fe, and the like as main constituent elements. The imaging element 6Fb is, for example, a CCD sensor or a CMOS sensor and outputs an image signal according to the quantity of light incident on each position of a light receiving surface thereof. The imaging optical system 6Fa converges the incident light on the light receiving surface to thereby form an optical image in the imaging field of view FV.

The controller 6Fc controls each component of the imager 6F, and the storage 6Fd stores therein various pieces of information. These pieces of information include information on the frame rate and/or the sensitivity, information on the setting of the imaging conditions and the setting of the regions of interest (ROI) described above, and the like as well as the image data generated by imaging. These components of the imager 6F cooperate with one another, to thereby achieve the imaging operation of the present embodiment described next. The interface 6Fe is connected to the control unit 9 through a communication channel CL, and receives a control command on imaging from the control unit 9 and sends the image data acquired by imaging to the control unit 9.

Further, since the sequential shutter function of performing imaging while switching the plurality of imaging conditions set in advance and the ROI setting function of converting only a partial region of interest in the imaging field of view into data and outputting the data, which are provided in the imager 6F, have already become commercially practical as described above, detailed description thereof will be omitted herein.

The imager 6F of this embodiment images the upper-surface image region Ma, the side-surface image region Mb, and the lower-surface image region Mc included in the imaging field of view FV under the respective optimal imaging conditions and does not convert any region other than these regions into data, to thereby solve both the above-described two problems. Specifically, three types of imaging conditions which are optimized to the upper-surface image region Ma, the side-surface image region Mb, and the lower-surface image region Mc, respectively, are set in advance, and the imager 6F periodically performs imaging while switching these three types of imaging conditions for each imaging.

It is assumed, herein, that three types of imaging conditions, i.e., an imaging condition (herein, referred to as an “imaging condition (1)”) suitable for the imaging of the upper-surface image region Ma, an imaging condition (herein, referred to as an “imaging condition (2)”) suitable for the imaging of the side-surface image region Mb, and an imaging condition (herein, referred to as an “imaging condition (3)”) suitable for the imaging of the lower-surface image region Mc, are used.

Further, though it is assumed that the length of the exposure time and the range of the region of interest are set as variable parameters used for determining the imaging condition in this embodiment, parameters to be used are not limited to these. Various factors affecting the image quality, such as the frame rate, the resolution or the sensitivity of the imaging element 6Fa, the f-number of the imaging optical system 6Fb, the quantity of illumination light, and the like, can be used as the variable parameters. Furthermore, specific numerical values or the like mentioned below are only setting examples taken for explanation, and a set value is not limited to these exemplary cases but can be changed as appropriate depending on the purpose.

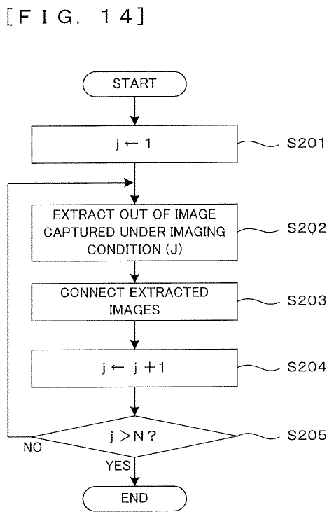

FIG. 11 is a chart showing exemplary imaging conditions. The imaging condition (1) is an imaging condition for optimizing the image quality in the imaging performed in a state where the upper surface of the substrate S is viewed downward from the upper direction. By performing imaging under this imaging condition (1), it is possible to acquire an image having the image quality suitable for the case where the observation targets are the A surface Sa and the B surface Sb in the peripheral edge part Ss of the substrate S, which can be viewed from above. For this purpose, the exposure time is set to be 100 μs. Further, as the region of interest (ROI) in the imaging field of view FV, set is a region Ra which can reliably and sufficiently include the upper-surface image region Ma and excludes any region unnecessary for observation if possible.

Further, the imaging condition (2) is an imaging condition for optimizing the image quality in the imaging performed in a state where the side surface of the substrate S is viewed from side. By performing imaging under this imaging condition (2), it is possible to acquire an image having the image quality suitable for the case where the observation targets are the B surface Sb, the C surface Sc, and the D surface Sd in the peripheral edge part Ss of the substrate S, which can be viewed from side. For this purpose, the exposure time is set to be 50 μs. Further, as the region of interest (ROI) in the imaging field of view FV, set is a region Rb which can reliably and sufficiently include the side-surface image region Mb and excludes any region unnecessary for observation if possible.

Furthermore, the imaging condition (3) is an imaging condition for optimizing the image quality in the imaging performed in a state where the lower surface of the substrate S is viewed upward from the lower direction. By performing imaging under this imaging condition (3), it is possible to acquire an image having the image quality suitable for the case where the observation targets are the D surface Sd and the E surface Se in the peripheral edge part Ss of the substrate S, which can be viewed from below. For this purpose, the exposure time is set to be 150 μs. Further, as the region of interest (ROI) in the imaging field of view FV, set is a region Rc which can reliably and sufficiently include the lower-surface image region Mc and excludes any region unnecessary for observation if possible.

FIG. 12 is a flowchart showing the imaging operation performed by the imager. This operation is performed when the imaging mechanism 6, particularly, the imager 6F operates in response to a control command from the control unit 9. Further, the operation of the imager 6F can be achieved when the controller 6Fc executes a control program stored in the storage 6Fd in advance. There may be another case, however, where the arithmetic processor 91 of the control unit 9 directly controls the imager 6F on the basis of the control program stored in the storage 92.

First, the frame rate and the imaging conditions in the periodic imaging are set (Step S101). In this embodiment, while the peripheral edge part Ss of the substrate S is periodically imaged, the value of the frame rate which is set first is maintained. In other words, the frame rate is not changed for each imaging. Further, as the imaging conditions, N (N is a natural number not less than 2) types of imaging conditions, i.e., the imaging condition (1) to the imaging condition (N) can be registered. In the above-described exemplary case, N=3 and the contents of each imaging condition are as described above. The pieces of information on these settings are given to the interface 6Fe of the imager 6F through the communication channel CL from the control unit 9 and stored into the storage 6Fd. Thus, the imaging conditions are registered in the imager 6F. From that time onward, the controller 6Fc controls the imaging element 6Fb and the like to perform imaging as follows while reading out these pieces of information from the storage 6Fd.

First, an internal parameter (intrinsic parameter) i is set to an initial value 1 (Step S102). Then, among the imaging conditions registered in advance, the imaging condition (i) specified by the internal parameter i is selected (Step S103), and the imaging (exposure) to which the imaging condition is applied is performed (Step S104).

The controller 6Fc converts an image of a region of interest in the exposed imaging field of view FV into data and the generated image data are outputted to the control unit 9 through the interface 6Fe (Step S105). The image data received by the control unit 9 are stored into the storage 92. Since the internal parameter i is 1 in the first processing, the imaging condition (1) is applied to the imaging and only the image data on the region of interest Ra set corresponding to the upper-surface image region Ma are outputted. Therefore, it is possible to image the upper-surface image region Ma with excellent image quality and moreover reduce the amount of data to be outputted.

After the first imaging is performed thus, the internal parameter i is incremented by 1 (Step S106), and Steps S103 to S105 are repeated until the conditional expression “i>N” is satisfied (Step S107). The imaging condition (2) is thereby applied in the second imaging and the image data of the region of interest Rb set corresponding to the side-surface image region Mb are outputted. Similarly, the imaging condition (3) is applied in the third imaging and the image data of the region of interest Rc set corresponding to the lower-surface image region Mc are outputted. Further, from the fourth imaging and onward, the imaging conditions (1) to (3) are cyclically applied and the image data of the regions of interest Ra, Rb, Rc, Ra, . . . are sequentially acquired under the respective optimal imaging conditions.

The above-described imaging operation is repeated while the substrate S is rotated at a predetermined speed. When the images corresponding to at least one rotation (one circumference) of the substrate S are acquired, it is possible to determine that imaging is ended (Step S108). Thus, the image data of the region of interest Ra imaged under the imaging condition (1), the image data of the region of interest Rb imaged under the imaging condition (2), and the image data of the region of interest Rc imaged under the imaging condition (3) are acquired for every one rotation of the substrate S. By using these image data, it is possible to form an entire peripheral edge image obtained by viewing the peripheral edge part Ss of the substrate S from above, side, and below.

Herein, for later explanation, the processing loop of Steps S102 to S108 is defined as an “imaging loop”, and the imaging loop performed first is referred to as an “imaging loop 1” or simply as a “loop 1”. Further, from the second imaging loop and onward, the imaging loops are referred to as an “imaging loop 2” (or a “loop 2”), an “imaging loop 3” (or a “loop 3”), . . . and so on.

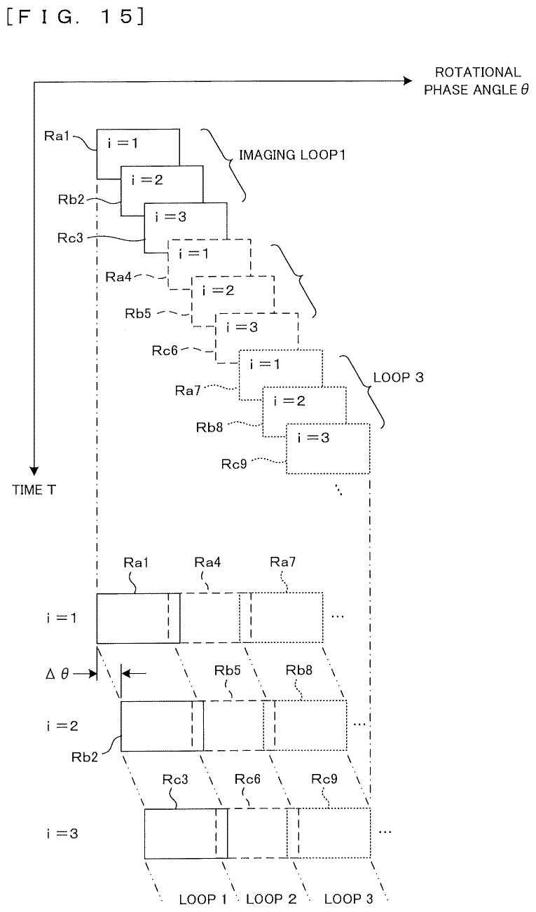

FIG. 13 is a conceptual diagram showing processing for forming the entire peripheral edge image from an imaging result. It is thought that an image Ra1 is acquired by imaging the region of interest Ra by applying the imaging condition (1) at the time T1 in the above-described imaging operation. Similarly, an image Rb2 is acquired by imaging the region of interest Rb by applying the imaging condition (2) at the time T2 and an image Rc3 is acquired by imaging the region of interest Rc by applying the imaging condition (3) at the time T3. At the time T4, the region of interest Ra is imaged by applying the imaging condition (1) again, to thereby acquire an image Ra4. Also from the time T5 onward, it can be thought that the operation like the above is performed.

The entire peripheral edge image obtained by viewing the peripheral edge part Ss of the substrate S from above can be formed by aligning the images Ra1, Ra4, Ra7, . . . , which are acquired by imaging the upper-surface image region Ma as the region of interest Ra under the imaging condition (1), in a direction corresponding to the circumferential direction of the substrate S and synthesizing these images. Further, the entire peripheral edge image obtained by viewing the peripheral edge part Ss of the substrate S from side can be formed by aligning the images Rb2, Rb5, Rb8, . . . , which are acquired by imaging the side-surface image region Mb as the region of interest Rb under the imaging condition (2), in the direction corresponding to the circumferential direction of the substrate S and synthesizing these images. Furthermore, the entire peripheral edge image obtained by viewing the peripheral edge part Ss of the substrate S from below can be formed by aligning the images Rc3, Rc6, Rc9, . . . , which are acquired by imaging the lower-surface image region Mc as the region of interest Rc under the imaging condition (3), in the direction corresponding to the circumferential direction of the substrate S and synthesizing these images.

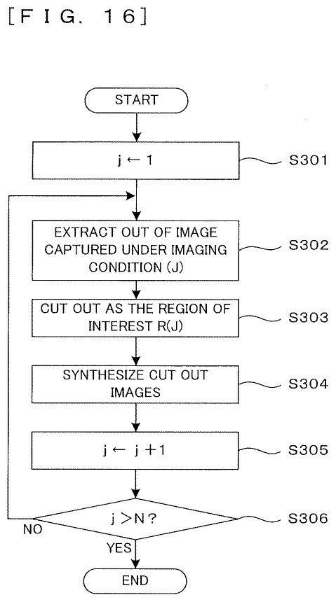

FIG. 14 is a flowchart showing image processing applicable to the formation of the entire peripheral edge image. This processing is achieved when the arithmetic processor 91 of the control unit 9 executes a control program stored in the storage 92 in advance to perform predetermined processing on the image data acquired by the imager 6F and stored in the storage 92.

First, an internal parameter (intrinsic parameter) j is set to an initial value 1 (Step S201). Then, an image captured under the imaging condition (j) is extracted out of the images whose data are stored in the storage 92 (Step S202), and by performing synthesizing processing of connecting the images corresponding to one rotation (one circumference) of the substrate S (Step S203), the entire peripheral edge image is formed. The image data of the entire peripheral edge image which is formed is stored into the storage 92. By repeating this processing N times (Step S205) while incrementing the internal parameter j by one (Step S204), all the necessary entire peripheral edge images are formed.

By synthesizing the images Ra1, Ra4, Ra7, . . . which are captured under the imaging condition (1), for example, it is possible to form the entire peripheral edge image obtained by viewing the peripheral edge part Ss of the substrate S from above. The same can be thought to apply to the respective images captured under the imaging condition (2) and the imaging condition (3).

Next, in the formation of the entire peripheral edge image performed by imaging the peripheral edge part Ss of the substrate S as described above, other problems to be considered will be described. In the above-described processing, the three regions of interest Ra, Rb, and Rc are sequentially imaged. For this reason, on one region of interest, one image can be acquired for every three imaging operations. In order to form the entire peripheral edge image, it is necessary to acquire an image of the peripheral edge part Ss without any lack of image information for one rotation of the substrate S. A relation between the imaging timing and the rotation speed of the substrate necessary to make it possible will be considered.

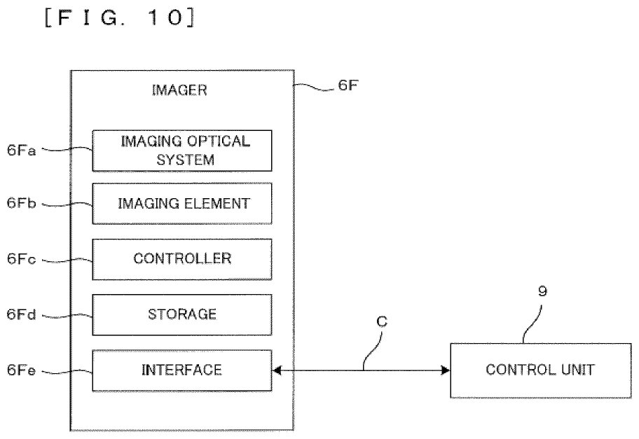

FIG. 15 is a diagram schematically showing a preferable relation between the imaging timing and the rotation speed of the substrate. As shown in FIG. 15, the imaging timing is considered in this diagram with the horizontal axis representing a rotational phase angle θ of the substrate S from a reference position determined as appropriate and the vertical axis representing the time T. When imaging is periodically performed while the internal parameter i is changed to 1, 2, 3, . . . , the image Ra1, Rb2, Rc3, . . . is sequentially acquired every time when the time T1, T2, T3, . . . for performing imaging comes. During this process, since the substrate S is rotated, the rotational phase angle θ is sequentially changed. Further, though the images of the regions of interest Ra, Rb, and Rc are shown herein to have the same size, for convenience of description, these images do not always have the same size as shown in FIG. 11.

The entire peripheral edge image of the region of interest Ra is formed by connecting the images Ra1, Ra4, Ra7, and . . . captured with i=1, i.e., under the imaging condition (1). At that time, in order to prevent any lack of the information on the substrate S, it is necessary that respective imaging ranges of these images Ra1, Ra4, and Ra7 overlap one another on the substrate S.

It is assumed herein that:
the width (imaging width) of the region of interest to be imaged by one imaging is represented by reference sign W [mm],
the frame rate of the imaging is represented by reference sign R [fps=frames per second],
the diameter of the substrate S is represented by reference sign D [mm],
and the number of revolution of the substrate S is represented by reference sign n

$$[ rpm = revolutions per minute ] = n / 60 [ rps = resolutions per second ] .$$

Since the number of imaging during one rotation of the substrate S is represented by (60 R/n), when N types of imaging conditions are cyclically switched, the number of imaging per one rotation under the same imaging condition can be represented by 60 R/(Nn). When N=3, for example, the number of imaging per one rotation under the same imaging condition can be represented by 20 R/n.

On the other hand, since the perimeter of the substrate S can be represented as πD by using the circular constant π, the condition for adjacent images to overlap one another under the same imaging condition is

$$W > π D / 60 R / ( Nn ) \} = π DNn / ( 60 R ) \qquad ( Eq . 1 )$$

When N=3, for example, (Eq. 1) can be rewritten by the following expression:

$$W > π Dn / ( 20 R ) \qquad ( Eq . 2 )$$

When each value is set so that this condition is satisfied, it is possible to acquire a plurality of images which have overlap portions. The technique for connecting images having different imaging ranges with overlap portions is well known, and it is possible to form an entire peripheral edge image without any missing portion by using such a well-known technique.

Further, since the diameter D and the number of revolution n of the substrate S are determined depending on specifications of substrate processing and the number of imaging conditions N is set according to the purpose of observation, it is thought that these cannot be arbitrarily selected. Therefore, actually, it is possible to ensure satisfaction of the above-described condition by selecting combination between the imaging width W and the frame rate R.

When the diameter D of the substrate S is 300 [mm], the number of revolution n=20 [rpm], and the number of imaging conditions N=3, as an example, (Eq. 1) can be rewritten by the following expression:

$$W > 300 π / R \qquad ( Eq . 3 )$$

In this case, by setting that W=3 [mm] and R=360 [fps], for example, the above-described condition is satisfied. Further, since the imaging cycle (1/R) at that time is about 2.8 ms, it is possible to sufficiently ensure the exposure time of 50 to 150 μs defined by each of the above-described imaging conditions.

In this regard, in a case where the three regions of interest are imaged under the single imaging condition at the same time, i.e., N=1, the frame rate R has only to be 120 fps when the same imaging width W (3 mm) is used. In other words, in order to achieve the present embodiment, needed is a frame rate higher than that in the imaging under the single condition. There is naturally an upper limit to the frame rate which can be achieved in a general imaging device. An imaging device having the ROI setting function, however, can achieve a frame rate higher than that in the case of converting the entire imaging field of view FV into data, by converting only the region of interest (ROI), not the entire imaging field of view FV, into data.

When the imaging element 6Fa uses the CCD sensor or the CMOS sensor, for example, since a photoelectrically-converted signal has only to be read out only on the region of interest, it is possible to achieve a frame rate higher than usual. Therefore, in an imaging device capable of imaging the entire imaging field of view FV with a frame rate of 120 fps, by setting the area of the region of interest for each imaging to be smaller than one third of that of the imaging field of view FV, for example, it is possible to achieve imaging with a frame rate of 360 fps.

Further, as shown in the lower part of FIG. 15, in the imaging operation of this embodiment, since the regions of interest Ra, Rb, and Rc are not imaged at the same time, there arises a positional difference of Δθ [rad] at an rotation angle of the substrate S among the images captured in the same imaging loop. Δθ can be expressed by the following equation:

$$Δ θ = 2 π n / ( 60 R ) = π n / ( 30 R ) \qquad ( Eq . 4 )$$

When observation is performed with respective positions compared with one another among the entire peripheral edge images formed under different imaging conditions, it is necessary to correct this positional difference.

Thus, in this embodiment, the head unit 6G having the three mirror members 62a to 62c causes the figures of the peripheral edge part Ss of the substrate S viewed from different directions, more specifically, all of the upper-surface image region Ma corresponding to the figure viewed from above, the side-surface image region Mb corresponding to the figure viewed from side, and the lower-surface image region Mc corresponding to the figure viewed from below to appear in the imaging field of view FV of the imager 6F.

Then, the imager 6F periodically performs imaging while cyclically switching the plurality of imaging conditions which are set and registered in advance and outputs only the image data of the regions of interest set by the imaging conditions. On the other hand, the arithmetic processor 91 which receives the image data extracts ones captured under the same imaging condition out of the plurality of images which are acquired thus and performs image processing thereon.

Thus, in the present embodiment, combined are a configuration for guiding the figures of the substrate S viewed from the plurality of directions to the imaging field of view FV, a configuration for performing imaging while cyclically switching the plurality of imaging conditions, a configuration for outputting only the image data of the regions of interest in the imaging field of view FV, and a configuration for extracting the images captured under the same imaging condition to perform image processing thereon. In the present embodiment, the following effects are thereby produced.

As the first effect, since the figures of the substrate S viewed from different directions can be imaged under the imaging conditions suitable for the respective figures, it is possible to acquire an image of any figure with excellent image quality. Then, as the second effect accompanying this, it is possible to acquire all the images under the respective optimized imaging conditions during one rotation of the substrate S.

As the third effect, it is possible to increase the speed of imaging by converting only the necessary region in the imaging field of view FV into data and achieve higher frame rate. As the fourth effect, by outputting only the image data of the necessary region, it is possible to reduce the data capacity and alleviate the constraint on the data communication channel and the storage resources. The effect becomes remarkable, particularly, in the case where processing is performed after acquiring the images corresponding to the entire circumference of the substrate S or the case where the image data outputted from the plurality of processing units 1 are processed.

Further, in the above-described embodiment, by using the ROI setting function of the imaging device, only a partial region in the imaging field of view FV is converted into data. In a case where there is an allowance in the frame rate and the data capacity, however, it is also possible to cut out portions corresponding to the regions of interest Ra, Rb, and Rc from the image obtained by imaging the entire imaging field of view FV without using the ROI setting function.

As the imaging operation in this case, the processing shown in FIG. 12 has only to be changed so that the entire imaging field of view FV is always the region of interest. The imaging is thereby performed in a state where the region of interest is constant but the other conditions, for example, the exposure time is changed for each imaging. The plurality of images obtained with the exposure times differentiated from one another with respect to the entire imaging field of view FV are thereby acquired. On the other hand, the image processing by the arithmetic processor 91 is performed as follows.

FIG. 16 is a flowchart showing a variation of the image processing. The processing in the variation is the same as that shown in FIG. 14 in that the internal parameter j is used and the image captured under the imaging condition (j) is acquired (Steps S301 and S302). The image captured at that time includes the upper-surface image region Ma, the side-surface image region Mb, and the lower-surface image region Mc. Only any of these image regions, however, is imaged with excellent image quality and the image quality of the other image regions is not necessarily ensured. Then, the region which can be imaged with excellent image quality under the imaging condition (j) is cut out as the region of interest R(j) (Step S303).

The image content of the region of interest R(j) which is cut out thus is substantially the same as that in the case where only the region of interest is converted into data on the imaging stage. Therefore, by synthesizing the regions of interest cut out from the images captured under the same imaging condition (Step S304), the entire peripheral edge image can be formed. This processing in the variation is also the same as that shown in FIG. 14 in repeating the processing while incrementing the parameter j (Steps S305 and S306).

As described above, in the above-described embodiment, the processing unit 1 has a function as an “imaging device”, a “substrate observation apparatus”, or a “substrate processing apparatus” of the present invention. Further, the rotating mechanism 2, the processing mechanism 4, and the arithmetic processor 91 function as a “rotating mechanism”, a “processor”, and an “image processor” of the present invention, respectively. Furthermore, the imager 6F and the head unit 6G of the imaging mechanism 6 function as an “imager” and an “optical guider” of the present invention, respectively, and the imaging mechanism 6 and the arithmetic processor 91 cooperate with each other to function as an “imaging device” and an “imaging mechanism” of the present invention. Further, the storage 6Fd provided in the imager 6F functions as a “storage” of the present invention.

Further, in this embodiment, the figures of the peripheral edge part Ss of the substrate S viewed from the upper direction, the side direction, and the lower direction are the observation targets, and it can be understood that one of these directions is a “first direction” of the present invention and one of the other directions is a “second direction” of the present invention. Similarly, it can be understood that one of these figures is a “first figure” of the present invention and one of the other figures is a “second figure” of the present invention, and the images which individually represent these figures correspond to a “first image” and a “second image” of the present invention, respectively. Furthermore, it can be understood that one of the plurality of imaging conditions (1) to (N) is a “first condition” of the present invention and one of the other conditions is a “second condition” of the present invention.

Further, the present invention is not limited to the above-described embodiment and numerous modifications and variations can be added to those described above without departing from the scope of the invention. In the embodiment, for example, assuming that the regions of interest individually including the respective figures of the peripheral edge part Ss of the substrate S viewed from the three directions, i.e., the upper direction, the side direction, and the lower direction are determined as the observation target, three types of imaging conditions adapted thereto are set. The number of regions of interest, however, is not limited to this number but may be set depending on the purpose as appropriate. Further, the number of regions of interest may not be the same as the number of imaging conditions to be set. In a case, for example, where the same imaging condition can be applied among a plurality of regions of interest, the images of the plurality of regions of interest can be acquired by one imaging.

On the contrary to this, one region of interest may be imaged under a plurality of different imaging conditions. By imaging one region of interest under a plurality of imaging conditions having different exposure times, for example, it is possible to acquire images having different brightnesses on the same region. Even in a case where there is a large variation in the surface state of the substrate S and the brightness thereof varies depending on the position, for example, by acquiring images captured with the exposure time differentiated, it becomes possible to efficiently perform observation.

As a specific example according to the above-described embodiment, when two types of imaging conditions having different exposure times are set for imaging of the upper-surface image region Ma and one type of imaging condition is set for each imaging of the side-surface image region Mb and the lower-surface image region Mc, for example, imaging is performed while four types of imaging conditions in total are cyclically switched. Then, as to the upper-surface image region Ma, it becomes possible to form two entire peripheral edge images having different brightnesses or the like by performing imaging under different imaging conditions.

Further, by imaging the same region of interest a plurality of times under the same imaging condition, for example, it is also possible to substantially increase the resolution and reduce the image noise. Furthermore, “the same region of interest” refers to a setting region in imaging and does not always mean that ranges to be actually imaged are the same. Specifically, since the substrate S being rotated are imaged a plurality of times at different times, ranges of the regions on the substrate S to be imaged are different bit by bit. As described above, however, since the amount of positional difference can be grasped on the basis of the number of revolution and the imaging cycle of the substrate S, it is possible to correct the positional difference as necessary.

Thus, it can be arbitrarily determined how many regions of interest are set in the imaging field of view FV and how many imaging conditions are set for each region of interest, and further it can be also arbitrarily determined which factor should be changed as the imaging condition.

Further, although the observation lens system of the imager 6F is constituted of the object-side telecentric lenses in the above-described embodiment, the configuration of the observation lens system of the imager 6F is not limited to this. The observation lens system of the imager 6F may be constituted of any other lenses.

Furthermore, the configuration of the diffusion surfaces 610 (61a to 61c) of the diffused illuminator 61 is not limited to this. When at least part of the diffused illuminator 61 or the holder 63 is formed of a metal material, the diffusion surfaces 61a to 61c may be obtained by applying shot blasting to a surface of the metal material.

Further, the material of the mirror members 62a to 62c is also not limited to Si (silicon). Specifically, any other material may be used only if the material is chemical resistant against the processing liquid and heat resistant against a processing temperature. The mirror members 62a to 62c may be formed by, for example, evaporating a metal material on a surface of the material having chemical resistance and heat resistance. Further, in a case where the mirror members 62a to 62c are used under an environment requiring neither chemical resistance nor heat resistance, the constituent material thereof is not limited. The mirror members 62a to 62c may be formed of a material which is neither chemical resistant nor heat resistant. The mirror members 62a to 62c may be formed by, for example, evaporating a metal material on a surface of the material having neither chemical resistance nor heat resistance.

Furthermore, in the above-described embodiment, the present invention is applied to the substrate processing apparatus 1 which performs the bevel etching processing on the peripheral edge part Ss of the substrate S. The present invention, however, is not limited to this but can be applied to a technique in general for performing imaging to observe the peripheral edge part of the substrate. The present invention can be also applied to, for example, an inspection technique for inspecting the substrate on the basis of the captured image, and the like. Further, the imaging mechanism 6 and the arithmetic processor 91 which correspond to the imaging device in accordance with the present invention can be also applied to, for example, a substrate processing apparatus for supplying the peripheral edge part of the substrate S on which a coating film is formed, with a removal liquid for the coating film, to remove the coating film from the peripheral edge part of the substrate S.

Furthermore, some of the processing units 1 of the above-described embodiment each include a processor for processing a substrate and an imager for imaging a peripheral edge part of the substrate. Also in a case where a device for processing the substrate and a device for imaging the substrate for observation are configured as separate bodies, however, the present invention can be applied as the image processing in the latter device.

Thus, as the specific embodiment has been exemplarily shown and described, in the imaging device in accordance with the present invention, the substrate observation apparatus and the substrate processing apparatus each having the imaging mechanism having the same configuration as that of the imaging device, and the imaging method using the imaging device, the imager may be capable of outputting the image data corresponding to the region of interest which is part of the imaging field of view and change-setting the region of interest. Further, in this case, setting on the range of the region of interest in the imaging field of view may be included in the imaging condition.

With such a configuration, it is possible to reduce the data capacity corresponding to the image to thereby reduce the load on the communication channel and the storage resources used to send the data. Further, by reducing the time required to convert the image into data to shorten the imaging cycle, it is possible to perform imaging with higher frame rate.

Further, for example, the imager may have a configuration to have a storage for storing therein a plurality of imaging conditions and apply the imaging condition read out from the storage to perform imaging. With such a configuration, the imager can periodically perform imaging while autonomously changing the imaging conditions, and it is not necessary to specify the imaging condition from the outside for each imaging.

Furthermore, for example, the imager may have a configuration to perform imaging a plurality of times under each of the plurality of imaging conditions during one rotation of the substrate. With such a configuration, it is possible to perform imaging at a plurality of positions of the peripheral edge part of the substrate while changing the position in the circumferential direction thereof. Further, by performing such imaging, the image processor can synthesize a plurality of first images captured at different times to form a synthetic image.

In this case, it is preferable that the imager should perform imaging so that the two first images captured at the closest imaging times partially overlap each other With such a configuration, it is possible to form a synthetic image which covers the entire circumference of the peripheral edge part of the substrate without any missing portion.

Further, as the plurality of imaging conditions, for example, the exposure time can be differentiated from one another. The optical state of the surface varies depending on the types of substrates, the processing state, or the like. For this reason, there are some cases where it is difficult to obtain the brightness suitable for observation and excellent image quality in all the directions in the imaging at a single exposure time. By performing imaging while differentiating the exposure time, this problem can be solved.

Furthermore, for example, the first figure may be a figure of the main surface of the substrate and the second figure may be a figure of the side surface of the substrate. In this invention, since the figures of the substrate viewed from a plurality of directions can be acquired with excellent image quality, it is possible to efficiently observe the main surface and the side surface of the substrate, which are largely different from each other in the surface state. For the purpose of inspecting the processing state of the bevel part of the substrate, for example, it is necessary to observe both the main surface side and the side surface side, and the present invention is suitable for such a purpose.

Although the invention has been described by way of the specific embodiments above, this description is not intended to be interpreted in a limited sense. By referring to the description of the invention, various modifications of the disclosed embodiments will become apparent to a person skilled in this art similarly to other embodiments of the invention. Hence, appended claims are thought to include these modifications and embodiments without departing from the true scope of the invention.

### INDUSTRIAL APPLICABILITY

This invention can be applied to the purpose of imaging and observing a peripheral edge part of a substrate, especially, a circular substrate such as a semiconductor wafer or the like, and in particular, can be applied suitably to the usage requiring observation of a circumferential direction of the substrate from a plurality of directions.

### REFERENCE SIGNS LIST

1 processing unit (imaging device, substrate observation apparatus, substrate processing apparatus)
2 rotating mechanism
4 processing mechanism
6 imaging mechanism
6E light source
6F imager
6Fd storage
6G head unit
91 arithmetic processor
S substrate
Ss peripheral edge part

1. An imaging device for imaging a peripheral edge part of a substrate being rotated, comprising:
an imager configured to periodically perform imaging;
an optical guider configured to guide light emitted from the peripheral edge part to the imager so as to form a first figure of the peripheral edge part viewed from a first direction and a second figure of the peripheral edge part viewed from a second direction different from the first direction in an imaging field of view of the imager; and
an arithmetic processor configured to perform image processing on each of a first image including the first figure and a second image including the second figure, the first image and the second image being captured by the imager,
wherein the imager cyclically switches a plurality of imaging conditions for each imaging, the imaging conditions including a first condition corresponding to imaging of the first figure and a second condition corresponding to imaging of the second figure, and
the arithmetic processor acquires the first image from an image captured by the imager under the first condition and acquires the second image from an image captured by the imager under the second condition.

2. The imaging device according to claim 1, wherein
the imager is configured to output image data corresponding to a region of interest, which is part of the imaging field of view, and to allow the region of interest to be changeably set.

3. The imaging device according to claim 2, wherein
the imaging condition includes setting on a range of the region of interest in the imaging field of view.

4. The imaging device according to claim 1, wherein
the imager has a storage storing therein the plurality of imaging conditions and is configured to perform the imaging by applying the imaging conditions read out from the storage.

5. The imaging device according to claim 1, wherein
the imager is configured to perform the imaging a plurality of times under each of the plurality of imaging conditions during one rotation of the substrate.

6. The imaging device according to claim 5, wherein
the arithmetic processor is configured to synthesize a synthetic image from a plurality of first images captured at different times.

7. The imaging device according to claim 6, wherein
the imager is configured to perform imaging so that the two first images captured at the closest imaging times partially overlap each other.

8. The imaging device according to claim 1, wherein
the exposure times in the first condition and the second condition are different from each other.

9. The imaging device according to claim 1, wherein
the first figure is a figure of a main surface of the substrate and the second figure is a figure of a side surface of the substrate.

10. A substrate observation apparatus, comprising:
a spin chuck configured to hold a substrate and to rotate the substrate about an axis of rotation perpendicular to a main surface of the substrate; and
an imaging element having the same configuration as that in the imaging device according to claim 1.

11. A substrate processing apparatus, comprising:
a spin chuck configured to hold a substrate and to rotate the substrate about an axis of rotation perpendicular to a main surface of the substrate;
a processor configured to perform predetermined processing on the substrate being rotated; and
an imaging element having the same configuration as that in the imaging device according to claim 1.

12. An imaging method for imaging a peripheral edge part of a substrate being rotated, comprising:
periodically performing imaging by an imager while guiding light emitted from the peripheral edge part to the imager, to thereby form a first figure of the peripheral edge part viewed from a first direction and a second figure of the peripheral edge part viewed from a second direction different from the first direction in an imaging field of view of the imager; and
performing image processing on each of a first image including the first figure and a second image including the second figure, which are captured by the imager,
wherein the imager cyclically switches a plurality of imaging conditions for each imaging, the plurality of imaging conditions including a first condition corresponding to imaging of the first figure and a second condition corresponding to imaging of the second figure, and
an arithmetic processor acquires the first image from an image captured by the imager under the first condition and acquires the second image from an image captured by the imager under the second condition.
